(19) United States
(12) Patent Application Publication
(10) Pub. No.: US 2026/0323385 A1
(43) Pub. Date: Oct. 15, 2026

(54) METHOD AND DEVICE FOR OPTIMIZING QOE IN WIRELESS COMMUNICATION SYSTEM

(71) Applicant: Samsung Electronics Co., Ltd., Suwon-si, Gyeonggi-do (KR)

(72) Inventors: Sunhyun KIM, Suwon-si (KR); Hyeondeok JANG, Suwon-si (KR); Suhwook KIM, Suwon-si (KR); Changsung LEE, Suwon-si (KR)

(21) Appl. No.: 19/144,339

(22) PCT Filed: Dec. 28, 2022
(86) PCT No.: PCT/KR2022/021528

§ 371 Date: Jun. 27, 2025

(51) Int. Cl. H04W 28/06; H04B 17/309; H04B 17/318; H04L 1/00; H04L 41/5067

(52) U.S. Cl. CPC H04W 28/06; H04B 17/328; H04B 17/346; H04L 1/0003; H04L 41/5067

(57) ABSTRACT

The present disclosure relates to a 5G or 6G communication system for supporting a higher data transmission rate beyond a 4G communication system such as LTE. A method for optimizing QoE for a base station according to an embodiment of the present disclosure may comprise a step for receiving a first message from a control entity (orchestrator) indicating that one network entity will perform QoE optimization. The method for optimizing QoE for a base station according to an embodiment of the present disclosure may comprise a step for receiving a second message from the control entity indicating that the network entity that will perform the QoE optimization is the base station. The method for optimizing QoE for a base station according to an embodiment of the present disclosure may comprise a step for receiving data for the QoE optimization from at least one of a user equipment (UE) and a server. The method for optimizing QoE for a base station according to an embodiment of the present disclosure may comprise a step for performing the QoE optimization for the UE on the basis of the data for the QoE optimization.

### TECHNICAL FIELD

The disclosure relates to an entity for optimizing QoE in a wireless communication system and a method for operating the same.

### BACKGROUND ART

Considering the development of wireless communication from generation to generation, the technologies have been developed mainly for services targeting humans, such as voice calls, multimedia services, and data services. Following the commercialization of 5G (5 th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6 th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collison avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

Meanwhile, measures of the overall acceptability of an application or service that is subjectively perceived by service users based on their expectations, and the quality of communication services include network performance (NP), quality of service (QoS), and QoE. NP focuses on the performance of the network itself, while QoS is the quality that may be provided by the service provider, and they are not directly related to the service satisfaction of individual users receiving the service. Recently, there has been a growing need for technologies to improve QoE, a quality measure that is defined based on users' expectations of a specific service.

### DETAILED DESCRIPTION OF THE INVENTION

### Technical Problem

The disclosure proposes a method for determining an entity that performs QoE optimization to improve QoE, a measure of the quality expected by a user for a specific service in a network.

### Technical Solution

According to an embodiment, a method for optimizing quality of experience (QoE) of a base station in a wireless communication system may comprise receiving, from a control entity (orchestrator), a first message (separated optimization(0)) indicating that one network entity is to perform QoE optimization, receiving, from the control entity, a second message (delegating indicator(1)) indicating that the network entity to perform the QoE optimization is the base station, receiving data for the QoE optimization from at least one of a user equipment (UE) and a server, and performing the QoE optimization for the UE based on the data for the QoE optimization.

According to an embodiment, the method for optimizing the QoE of the base station may further comprise receiving, from the control entity, information about the QoE provided from the server.

According to an embodiment, the method for optimizing the QoE of the base station may further comprise transmitting a message requesting the data for the QoE optimization to at least one of the UE and the server.

According to an embodiment, the data for the QoE optimization received from the UE may include at least one of an encoding parameter, traffic distribution information, pose information, and scene change information.

According to an embodiment, the data for the QoE optimization received from the server may include at least one of an encoding rate and a traffic pattern report.

According to an embodiment, a method for optimizing quality of experience (QoE) of a server in a wireless communication system may comprise receiving, from a control entity (orchestrator), a first message (separated optimization(0)) indicating that one network entity is to perform QoE optimization, receiving, from the control entity, a second message (delegating indicator(1)) indicating that the network entity to perform the QoE optimization is the server,
receiving data for the QoE optimization from at least one of a user equipment (UE) and a base station, and performing the QoE optimization for the UE based on the data for the QoE optimization.

According to an embodiment, the method for optimizing the QoE of the server may further comprise transmitting information about the QoE to the control entity.

According to an embodiment, the method for optimizing the QoE of the server may further comprise transmitting a message requesting the data for the QoE optimization to at least one of the UE and the base station.

According to an embodiment, the data for the QoE optimization received from the UE may include at least one of an encoding parameter, traffic distribution information, pose information, and scene change information.

According to an embodiment, the data for the QoE optimization received from the base station may include at least one of a signal to interference plus noise ratio (SINR), a reference signals received power (RSRP), a number of UEs connected, a modulation coding scheme (MCS) selection criterion, and a schedule policy.

According to an embodiment, a base station for optimizing quality of experience (QoE) in a wireless communication system comprises a transceiver and a controller. The controller may receive, from a control entity (orchestrator), a first message (separated optimization(0)) indicating that one network entity is to perform QoE optimization, receive, from the control entity, a second message (delegating indicator(1)) indicating that the network entity to perform the QoE optimization is the base station, receive data for the QoE optimization from at least one of a user equipment (UE) and a server, and perform the QoE optimization for the UE based on the data for the QoE optimization.

According to an embodiment, a server for optimizing quality of experience (QoE) in a wireless communication system comprises a transceiver and a controller. The controller may receive, from a control entity (orchestrator), a first message (separated optimization(0)) indicating that one network entity is to perform QoE optimization, receive, from the control entity, a second message (delegating indicator(1)) indicating that the network entity to perform the QoE optimization is the server, receive data for the QoE optimization from at least one of a user equipment (UE) and a base station, and perform the QoE optimization for the UE based on the data for the QoE optimization.

### Advantageous Effects

A control entity according to an embodiment of the disclosure may efficiently determine at least one entity performing QoE optimization in a network.

A control entity according to an embodiment of the disclosure may increase transmission/reception efficiency by determining whether each entity in a network performs QoE optimization or only a designated entity performs QoE optimization.

### BRIEF DESCRIPTION OF DRAWINGS

FIG. 1 illustrates a wireless communication system according to an embodiment of the disclosure;

FIG. 2 is a view illustrating a QoE global optimization method performed by an orchestrator according to an embodiment of the disclosure;

FIG. 3 is a view illustrating a QoE optimization method performed by each of a UE, a base station, and a server according to an embodiment of the disclosure;

FIG. 4 is a view illustrating a QoE optimization method performed by a base station according to an embodiment of the disclosure;

FIG. 5 is a view illustrating a QoE optimization method performed by a server according to an embodiment of the disclosure;

FIG. 6 is a view illustrating an operation method of an orchestrator according to an embodiment of the disclosure;

FIG. 7 is a view illustrating a QoE optimization method when an orchestrator is implemented in a server according to an embodiment of the disclosure;

FIG. 8 is a view illustrating a QoE optimization method performed by a base station according to an embodiment of the disclosure;

FIG. 9 is a view illustrating a process in which a network entity selects a control layer according to an embodiment of the disclosure;

FIG. 10 illustrates a structure of a UE according to an embodiment of the disclosure;

FIG. 11 illustrates a structure of a base station according to an embodiment of the disclosure; and

FIG. 12 illustrates a structure of a network entity according to an embodiment of the disclosure.

### MODE FOR CARRYING OUT THE INVENTION

Hereinafter, various embodiments of the disclosure are described in detail with reference to the accompanying drawings. The same reference denotations may be used to refer to the same or similar elements throughout the specification and the drawings. When making the gist of the present invention unclear, the detailed description of known functions or configurations is skipped.

In describing the embodiments of the disclosure, the description of technologies that are known in the art and are not directly related to the present invention is omitted. This is for further clarifying the gist of the present disclosure without making it unclear.

For the same reasons, some elements may be exaggerated or schematically shown. The size of each element does not necessarily reflects the real size of the element. The same reference numeral is used to refer to the same element throughout the drawings.

Advantages and features of the present disclosure, and methods for achieving the same may be understood through the embodiments to be described below taken in conjunction with the accompanying drawings. However, the present invention is not limited to the embodiments disclosed herein, and various changes may be made thereto. The embodiments disclosed herein are provided only to inform one of ordinary skilled in the art of the category of the present disclosure. The present invention is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card.

According to embodiments of the disclosure, the base station may be an entity allocating resource to terminal and may be at least one of gNode B, gNB, eNode B, eNB, Node B, base station (BS), wireless access unit, base station controller, or node over network. The base station may be a network entity including at least one of an integrated access and backhaul-donor (IAB-donor), which is a gNB providing network access to UE(s) through a network of backhaul and access links in the NR system, and an IAB-node, which is a radio access network (RAN) node supporting NR backhaul links to the IAB-donor or another IAB-node and supporting NR access link(s) to UE(s). The UE is wirelessly connected through the IAB-node and may transmit/receive data to and from the IAB-donor connected with at least one IAB-node through the backhaul link.

Further, the UE may include a user equipment (UE), a mobile station (MS), a cellular phone, a smart phone, a computer, or various devices capable of performing a communication function. In the disclosure, downlink (DL) refers to a wireless transmission path of signal transmitted from the base station to the terminal, and uplink (UL) refers to a wireless transmission path of signal transmitted from the terminal to the base station. Although the LTE or LTE-A systems may be described below as an example, embodiments of the disclosure may be applied to other communication systems having a similar technical background or channel shape. For example, 5G mobile communication technology (5G, new radio, NR) developed after LTE-A may be included therein, and 5G below may be a concept including legacy LTE, LTE-A and other similar services. Further, the embodiments may be modified in such a range as not to significantly depart from the scope of the present invention under the determination by one of ordinary skill in the art and such modifications may be applicable to other communication systems.

As used herein, terms denoting signals, terms denoting channels, terms denoting control information, terms denoting network entities, and terms denoting device components are provided as an example for ease of description. As used herein, terms for identifying nodes, terms denoting messages, terms denoting inter-network entity interfaces, and terms denoting various pieces of identification information are provided as an example for ease of description. The disclosure is not limited to the terms, and other terms equivalent in technical concept may also be used.

Further, although the disclosure describes various embodiments using terms used in some communication standards (e.g., 3rd generation partnership project (3GPP)), this is merely an example for description. Various embodiments of the disclosure may be easily modified and applied in other communication systems.

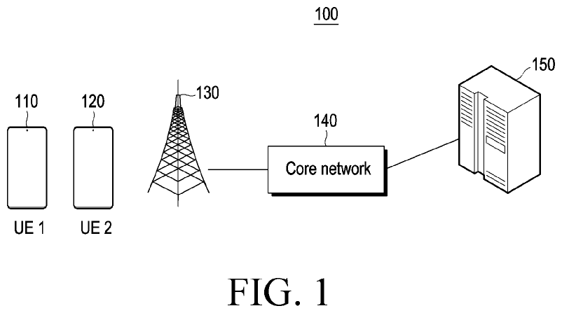

FIG. 1 illustrates a wireless communication system according to an embodiment of the disclosure.

Referring to FIG. 1, a wireless communication system 100 may include a first UE 110, a second UE 120, a base station 130, a core network 140, and a server 150. The base station 130 may include a radio unit (RU), a distributed unit (DU), and a control unit or central unit (CU) that may be functionally distinguished. According to an embodiment, the RU may serve as an antenna of the base station 130. The DU may perform functions of a portion of layer 1, layer 2, and/or layer 3 of the base station 130. The CU may perform a control function in a portion of layer 2 and/or layer 3 of the base station 130. The core network 140 may include at least one network function or network entity.

If global optimization (global optimization) for end-to-end (E2E) quality of experience (QoE) is performed in open systems interconnection (OSI) layer (medium access control (MAC)/transmission control protocol (TCP)/application), computational complexity (e.g., knapsack problem) and/or signal overhead may increase. On the other hand, if each layer independently performs optimization for QoE without information about other entities, the inefficiency of optimization may occur. For example, even if the video bitrate is decreased to reduce the delay of the UE, the RAN-visible BS may allocate an additional resource block (RB).

In the disclosure, QoE may be a quality value that represents the user experience for a service (e.g., application, web browsing, phone call, or TV broadcasting). According to an embodiment, QoE may be a quality measure value defined based on an expectation of the user for a service that the user has paid for.

According to an embodiment, each OSI layer may be positioned in each entity. According to an embodiment, the entity may mean a node of such a type as the UE 110 and/or 120, the base station 130, or the server 150. According to an embodiment, the entity may mean a network function such as a network data analytics function (NWDAF) or a RAN intelligent controller (RIC) included in the core network 140. For example, MAC may be positioned in the base station 130, TCP, and application may be positioned in the UE 110 and/or 120 and the server 150. According to an embodiment, orchestration between the application/TCP may be performed in each entity.

The disclosure proposes a method for determining at least one entity to perform optimal resource allocation in a wireless communication system and allocating optimal resources by the determined at least one entity.

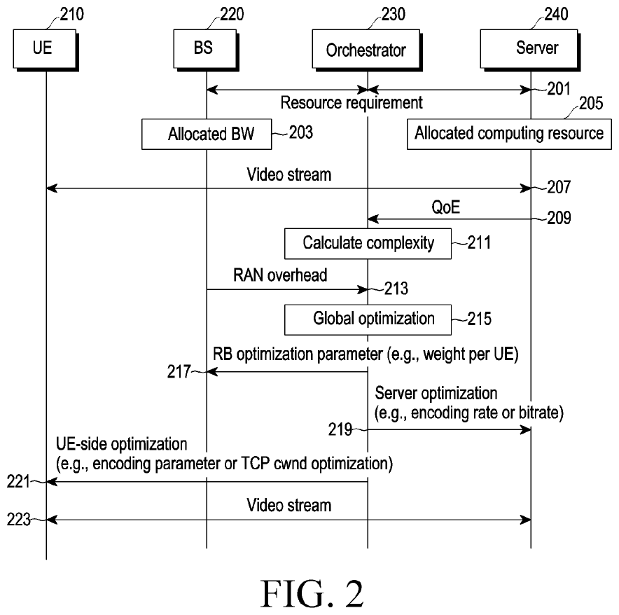

FIG. 2 is a view illustrating a QOE global optimization method performed by an orchestrator according to an embodiment of the disclosure.

Referring to FIG. 2, a wireless communication system may include a UE 210, a base station 220, an orchestrator 230, and a server 240. According to an embodiment, the orchestrator 230 may also be referred to as a network entity or a control entity. For example, the orchestrator 230 may be implemented in a network data analytics function (NWDAF) or a RAN intelligent controller (RIC). For example, the orchestrator 230 may be implemented in a network function (NF) in the core network. For example, the orchestrator 230 may be implemented in a non-RT RIC of the O-RAN.

In operation 201, the orchestrator 230 may exchange resource requirements with at least one of the base station 220 and the server 240. According to an embodiment, the orchestrator 230 may request resource allocation from at least one of the UE 210, the base station 220, and the server 240.

In operation 203, the base station 220 may identify an allocated bandwidth (BW). In operation 205, the server 240 may identify an allocated compute resource. According to an embodiment, RAN slicing may be defined (or configured) in the UE 210 and/or the base station 220 connected to the server 240.

In operation 207, the UE 210 may transmit and/or receive a video stream with the server 240 based on the allocated resource.

In operation 209, the server 240 may transmit information about QoE to the orchestrator 230. For example, the information about QoE may be a delay value in an AI analysis application. According to an embodiment, the server 240 may define (or configure) application QoE for the connected UE 210 and transmit application QoE for the UE 210 to the orchestrator 230.

In operation 211, the orchestrator 230 may calculate optimization complexity based on the QoE information received from the server 240. According to an embodiment, the orchestrator 230 may calculate optimization complexity (e.g., schedule operation) considering control variables (e.g., RB allocation, QoS flow identifier (QFI), and/or video bitrate). According to an embodiment, the optimization complexity may be calculated differently according to the number M of UEs and the number N of control variables.

In operation 213, the base station 220 may transmit the RAN overhead message to the orchestrator 230 to identify whether QoE optimization is possible in the base station 220. In operation 215, the orchestrator 230 may perform global optimization. According to an embodiment, if the global optimization algorithm is at a level operable in real-time in the orchestrator 230 (e.g., if the number M of UEs and/or the number N of control variables is small), the orchestrator 230 may perform global optimization and notify each entity thereof. For example, if the number of compute clocks available on the calculation chip of the orchestrator 230 is Δc and the calculation amount c0 of the optimization is smaller than Δc, the orchestrator 230 may perform global optimization.

In operation 217, the orchestrator 230 may transmit the RB optimization parameter (e.g., weight per UE) determined based on the global optimization result to the base station 220. In operation 219, the orchestrator 230 may transmit a server optimal value (e.g., encoding rate and/or bitrate) determined based on the global optimization result to the server 240. In operation 221, the orchestrator 230 may transmit the UE-side optimal value (e.g., encoding parameter and/or TCP cwnd optimization) determined based on the global optimization result to the UE 210. In operation 223, the UE 210 may transmit and/or receive a video stream with the server 240 based on the resource allocated according to operations 215 to 221.

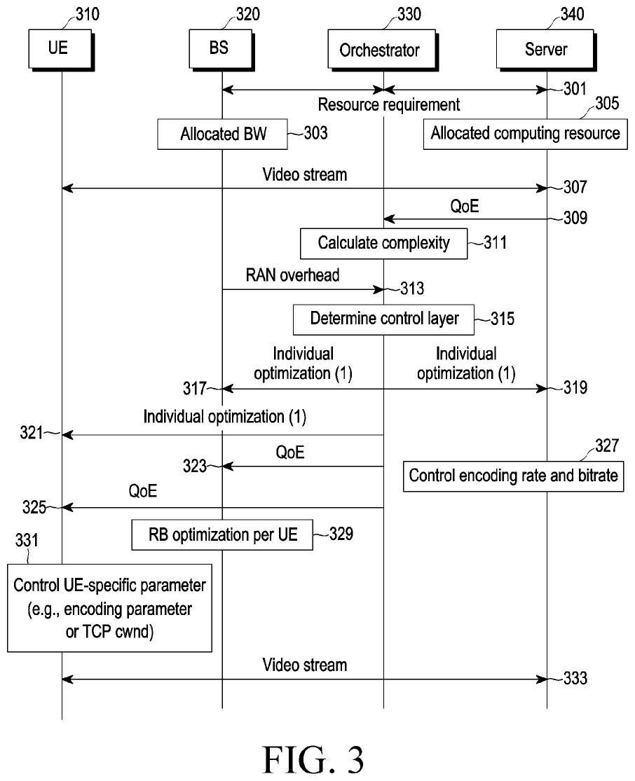

FIG. 3 is a view illustrating a QOE optimization method performed by each of a UE, a base station, and a server according to an embodiment of the disclosure.

Referring to FIG. 3, a wireless communication system may include a UE 310, a base station 320, an orchestrator 330, and a server 340. For example, the orchestrator 330 may be implemented in the NWDAF or the RIC. For example, the orchestrator 330 may be implemented in a network function (NF) in the core network. For example, the orchestrator 330 may be implemented in a non-RT RIC of the O-RAN.

In operation 301, the orchestrator 330 may exchange resource requirements with at least one of the base station 320 and the server 340. According to an embodiment, the orchestrator 330 may request resource allocation from at least one of the UE 310, the base station 320, and the server 340.

In operation 303, the base station 320 may identify an allocated bandwidth (BW). In operation 305, the server 340 may identify an allocated compute resource. According to an embodiment, RAN slicing may be defined (or configured) in the UE 310 and/or the base station 320 connected to the server 340.

In operation 307, the UE 210 may transmit and/or receive a video stream with the server 340 based on the allocated resource.

In operation 309, the server 340 may transmit information about QoE to the orchestrator 330. For example, the information about QoE may be a delay value in an AI analysis application. According to an embodiment, the server 340 may define (or configure) application QoE for the connected UE 310 and transmit application QoE for the UE 310 to the orchestrator 330.

In operation 311, the orchestrator 330 may calculate complexity based on the QoE information received from the server 340. According to an embodiment, the orchestrator 330 may calculate optimization complexity (e.g., schedule operation) considering control variables (e.g., RB allocation, QoS flow identifier (QFI), and/or video bitrate). According to an embodiment, the optimization complexity may be calculated differently according to the number M of UEs and the number N of control variables.

In operation 313, the base station 320 may transmit the RAN overhead message to the orchestrator 330 to identify whether QoE optimization is possible in the base station 320.

According to an embodiment, if the global optimization algorithm is not at a level operable in real-time in the orchestrator 330 (e.g., if the number M of UEs and/or the number N of control variables is large), the orchestrator 330 may determine at least one entity to perform QoE optimization without performing global optimization. For example, if the number of compute clocks available on the calculation chip of the orchestrator 330 is Δc and the calculation amount c0 of the optimization is larger than Δc, the orchestrator 330 may not perform global optimization.

In operation 315, the orchestrator 330 may determine at least one control layer (or at least one entity) to perform QoE optimization. The orchestrator 330 may transmit a separated optimization message indicating whether each entity is to perform QoE optimization or only one entity is to perform QoE optimization to at least one of the UE 310, the base station 320, and the server 340. According to an embodiment, the separated optimization message may be implemented in preset bits (e.g., 1 bit). For example, if the separated optimization message is set to “1”, it may indicate that each entity is to perform QoE optimization, and if the separated optimization message is set to “0”, it may indicate that only one entity is to perform QoE optimization.

For example, if the server 340 reduces the video bitrate (traffic control of the application) and the base station 320 allocates additional RBs to the UE 310 to significantly reduce the delay of the UE 310, each entity may perform QoE optimization separately. For example, if the server 340 reduces the video bitrate (traffic control of the application) and the base station 320 allocates additional RBs to the UE 310 to slightly control the delay of the UE 310, only one entity may perform QoE optimization.

For example, if there is a large shortage of RB resources overall (e.g., heavy video traffic and small BW), both traffic and RB may be controlled for optimization. For example, if there is no shortage of RB resources as a whole, only the RB may be controlled but traffic may not be decreased.

In operation 317, the orchestrator 330 may transmit a separated optimization message (e.g., set to “1”) indicating that each entity is to perform QoE optimization to the base station 320. In operation 319, the orchestrator 330 may transmit a separated optimization message (e.g., set to “1”) indicating that each entity is to perform QoE optimization to the server 340. In operation 321, the orchestrator 330 may transmit a separated optimization message (e.g., set to “1”) indicating that each entity is to perform QoE optimization to the UE 310.

In operation 323, the orchestrator 330 may transmit the QoE information received from the server 340 to the base station 320. In operation 325, the orchestrator 330 may transmit information about QoE received from the server 340 to the UE 310.

In operation 327, the server 340 may perform QoE optimization and determine a server optimal value (e.g., encoding rate and/or bitrate) based on the QoE optimization result. In operation 329, the base station 320 may perform QoE optimization and determine an RB optimization parameter (e.g., weight per UE) based on the QoE optimization result. In operation 331, the UE 310 may perform QoE optimization and determine and/or control UE specific parameters (e.g., encoding parameters and/or TCP cwnd optimization) based on the QoE optimization results. In operation 333, the UE 310 may transmit and/or receive a video stream with the server 340 based on the resources allocated according to operations 315 to 331.

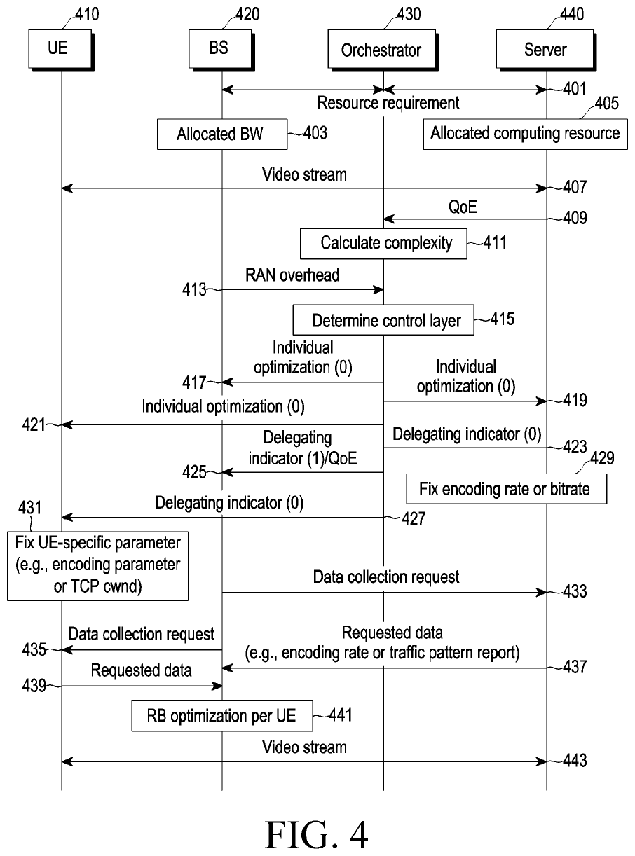

FIG. 4 is a view illustrating a QoE optimization method performed by a base station according to an embodiment of the disclosure.

Referring to FIG. 4, a wireless communication system may include a UE 410, a base station 420, an orchestrator 430, and a server 440. For example, the orchestrator 430 may be implemented in the NWDAF or the RIC. For example, the orchestrator 430 may be implemented in a network function (NF) in the core network. For example, the orchestrator 430 may be implemented in a non-RT RIC of the O-RAN.

In operation 401, the orchestrator 430 may exchange resource requirements with at least one of the base station 420 and the server 440. According to an embodiment, the orchestrator 430 may request resource allocation from at least one of the UE 410, the base station 420, and the server 440.

In operation 403, the base station 420 may identify an allocated bandwidth (BW). In operation 405, the server 440 may identify an allocated compute resource. According to an embodiment, RAN slicing may be defined (or configured) in the UE 410 and/or the base station 420 connected to the server 440.

In operation 407, the UE 410 may transmit and/or receive a video stream with the server 440 based on the allocated resource.

In operation 409, the server 440 may transmit information about QoE to the orchestrator 430. For example, the information about QoE may be a delay value in an AI analysis application. According to an embodiment, the server 440 may define (or configure) application QoE for the connected UE 410 and transmit application QoE for the UE 410 to the orchestrator 430.

In operation 411, the orchestrator 430 may calculate complexity based on the QoE information received from the server 440. According to an embodiment, the orchestrator 430 may calculate optimization complexity (e.g., schedule operation) considering control variables (e.g., RB allocation, QoS flow identifier (QFI), and/or video bitrate). According to an embodiment, the optimization complexity may be calculated differently according to the number M of UEs and the number N of control variables.

In operation 413, the base station 420 may transmit the RAN overhead message to the orchestrator 430 to identify whether QoE optimization is possible in the base station 420. In operation 415, the orchestrator 430 may determine a control layer (or at least one entity) to perform QoE optimization.

The orchestrator 430 may transmit a separated optimization message indicating whether each entity is to perform QoE optimization or only one entity is to perform QoE optimization to at least one of the UE 410, the base station 420, and the server 440. According to an embodiment, the separated optimization message may be implemented in preset bits (e.g., 1 bit). For example, if the separated optimization message is set to “1”, it may indicate that each entity is to perform QoE optimization, and if the separated optimization message is set to “0”, it may indicate that only one entity is to perform QoE optimization.

The orchestrator 430 may transmit a delegating indicator for indicating the entity to perform QoE optimization to at least one of the UE 410, the base station 420, and the server 440. According to an embodiment, the delegating indicator may be implemented in preset bits (e.g., 1 bit). For example, if the delegating indicator is set to “1”, it may indicate that the entity receiving the same is to perform QoE optimization, and if the delegating indicator is set to “0”, the entity receiving the same may not perform QoE optimization. According to an embodiment, if the delegating indicator is set to “0”, the entity receiving the same may maintain (or fix) the parameters related to QoE optimization without changing them.

According to an embodiment, if it is determined that the base station 420 is to perform QoE optimization, the possibility of more efficiently using radio resources in a fluctuated channel may increase. According to an embodiment, if it is determined that the server 440 is to perform QoE optimization, the possibility of performing a complex optimization process more efficiently may increase.

According to an embodiment, the orchestrator 430 may determine an entity to perform QoE optimization considering RAN overhead or whether there is room to perform QoE optimization in the RAN.

For example, if the RAN overhead (e.g., the number of UEs and/or CPU utilization) is larger than a threshold, the orchestrator 430 may determine the server 440 to perform QoE optimization. For example, if the RAN overhead is smaller than the threshold, the orchestrator 430 may determine the base station 420 to perform QoE optimization.

For example, if the average BSR of UE 410 and/or server 440 is larger than the threshold, the amount of data itself should be decreased, so orchestrator 430 may determine server 440 to perform QoE optimization. For example, if the average BSR of the UE 410 and/or the server 440 is smaller than the threshold, the orchestrator 430 may determine the base station 420 to perform QoE optimization.

In operation 417, the orchestrator 430 may transmit a separated optimization message (e.g., set to “0”) indicating that only one entity is to perform QoE optimization to the base station 420. In operation 419, the orchestrator 430 may transmit a separated optimization message (e.g., set to “0”) indicating that only one entity is to perform QoE optimization to the server 440. In operation 421, the orchestrator 430 may transmit a separated optimization message (e.g., set to “0”) indicating that only one entity is to perform QoE optimization to the UE 410.

In operation 423, the orchestrator 430 may transmit, to the server 440, a delegating indicator (e.g., set to “0”) indicating that the server 440 is not to perform QoE optimization. In operation 425, the orchestrator 430 may transmit information about QoE received from the server 440 and the delegating indicator (e.g., setting “1”) indicating that the base station 420 is to perform QoE optimization to the base station 420. In operation 427, the orchestrator 430 may transmit, to the UE 410, a delegating indicator (e.g., set to “0”) indicating that the UE 410 is not to perform QoE optimization.

According to an embodiment, the separated optimization message and the delegating indicator may be transmitted simultaneously. According to an embodiment, one message may be configured by combining the separated optimization message and the delegating indicator.

In operation 429, the server 440 may fix a server optimal value (e.g., encoding rate and/or bitrate) related to QoE optimization. In operation 431, UE 410 may fix UE-specific parameters (e.g., encoding parameters and/or TCP cwnd optimization) related to QoE optimization.

In operation 433, the base station 420 may transmit a data collection request message requesting a parameter value required for QoE optimization to the server 440. In operation 435, the base station 420 may transmit a data collection request message requesting a parameter value required for QoE optimization to the UE 410.

In operation 437, the base station 420 may receive a parameter value (e.g., encoding rate, bitrate, and/or traffic pattern report) necessary for QoE optimization from the server 440. In operation 439, the base station 420 may receive a parameter value (e.g., encoding parameters and/or TCP cwnd optimization) required for QoE optimization from the UE 410.

In operation 441, the base station 420 may optimize the RB to be allocated to the UE 410 based on the parameter value required for QoE optimization received from the server 440 in operation 437, and the parameter value required for QoE optimization received from the UE 410 in operation 439. In operation 443, the UE 410 may transmit and/or receive a video stream with the server 440 based on the resources allocated according to operation 429, 431, and 441.

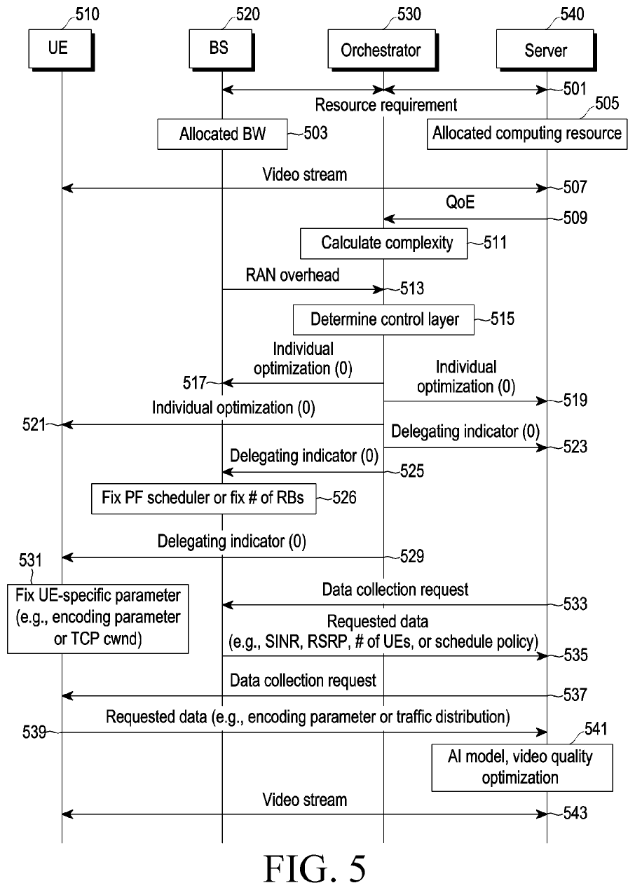

FIG. 5 is a view illustrating a QOE optimization method performed by a server according to an embodiment of the disclosure.

Referring to FIG. 5, a wireless communication system may include a UE 510, a base station 520, an orchestrator 530, and a server 540. For example, the orchestrator 530 may be implemented in the NWDAF or the RIC. For example, the orchestrator 530 may be implemented in a network function (NF) in the core network. For example, the orchestrator 530 may be implemented in a non-RT RIC of the O-RAN.

In operation 501, the orchestrator 530 may exchange resource requirements with at least one of the base station 520 and the server 540. According to an embodiment, the orchestrator 530 may request resource allocation from at least one of the UE 510, the base station 520, and the server 540.

In operation 503, the base station 520 may identify an allocated bandwidth (BW). In operation 505, the server 540 may identify an allocated compute resource. According to an embodiment, RAN slicing may be defined (or configured) in the UE 510 and/or the base station 520 connected to the server 540.

In operation 507, the UE 510 may transmit and/or receive a video stream with the server 540 based on the allocated resource.

In operation 509, the server 540 may transmit information about QoE to the orchestrator 530. For example, the information about QoE may be a delay value in an AI analysis application. According to an embodiment, the server 540 may define (or configure) application QoE for the connected UE 510 and transmit application QoE for the UE 510 to the orchestrator 530.

In operation 511, the orchestrator 530 may calculate complexity based on the QoE information received from the server 540. In operation 513, the base station 520 may transmit the RAN overhead message to the orchestrator 530 to identify whether QoE optimization is possible in the base station 520. In operation 515, the orchestrator 530 may determine a control layer (or at least one entity) to perform QoE optimization.

In operation 517, the orchestrator 530 may transmit a separated optimization message (e.g., set to “0”) indicating that only one entity is to perform QoE optimization to the base station 520. In operation 519, the orchestrator 530 may transmit a separated optimization message (e.g., set to “0”) indicating that only one entity is to perform QoE optimization to the server 540. In operation 521, the orchestrator 530 may transmit a separated optimization message (e.g., set to “0”) indicating that only one entity is to perform QoE optimization to the UE 510.

In operation 523, the orchestrator 530 may transmit, to the server 540, a delegating indicator (e.g., set to “1”) indicating that the server 540 is to perform QoE optimization.

In operation 525, the orchestrator 530 may transmit, to the base station 520, a delegating indicator (e.g., set to “0”) indicating that the base station 520 is not to perform QoE optimization. In operation 527, the base station 520 may fix a proportional fair (PF) scheduler related to QoE optimization or fix the number of RBs related to QoE optimization.

In operation 529, the orchestrator 530 may transmit, to the UE 510, a delegating indicator (e.g., set to “0”) indicating that the UE 510 is not to perform QoE optimization. In operation 531, UE 510 may fix UE-specific parameters (e.g., encoding parameters and/or TCP cwnd optimization) related to QoE optimization.

According to an embodiment, the separated optimization message and the delegating indicator may be transmitted simultaneously. According to an embodiment, one message may be configured by combining the separated optimization message and the delegating indicator.

In operation 533, the server 540 may transmit a data collection request message requesting a parameter value required for QoE optimization to the base station 520. In operation 535, the server 540 may receive a parameter value (e.g., signal to interference plus noise ratio (SINR), a reference signals received power (RSRP), the number of connected UEs, an MCS selection criterion, and/or a schedule policy) required for QoE optimization from the base station 520.

In operation 537, the server 540 may transmit a data collection request message requesting a parameter value required for QoE optimization to the UE 510. In operation 539, the server 540 may receive a parameter (e.g., pose information, information about a scene change, encoding parameter, and/or traffic distribution) required for QoE optimization from the UE 510.

In operation 541, the server 540 may optimize the AI model and/or video quality based on the parameter value required for QoE optimization received from the base station 520 in operation 535, and the parameter value required for QoE optimization received from the UE 510 in operation 539. In operation 543, the UE 510 may transmit and/or receive a video stream with the server 540 based on the resources allocated according to operation 527, 531, and 541.

According to an embodiment, the base station 520 may periodically or aperiodically transmit a RAN overhead message (e.g., whether CPU utilization/QoE optimization is possible) to the orchestrator 530.

According to an embodiment, the base station 520 may transmit a RAN overhead message in an event trigger method (e.g., when the RAN overhead is changed to a predetermined value or more). According to an embodiment, the orchestrator 530 may request a RAN overhead message from the base station 520.

According to an embodiment, when QoE optimization is controlled by the base station 520 (e.g., in a circumstance where RAN overhead is small or the number of UEs is small compared to the DU's compute resources), the orchestrator 530 may transfer QoE metrics itself to the base station 520 (RAN-visible), so that an RB schedule for each UE may proceed. According to an embodiment, the base station 520 performs QoE optimization, and the UE 510 and/or the server 540 may fix the corresponding control variable (e.g., the encoding rate). According to an embodiment, the base station 520 may allocate an RB per UE or per stream.

According to an embodiment, when the UE 510 and/or the server 540 controls QoE optimization, if the RAN overhead is large, the base station 520 may perform only the existing schedule (e.g., PF). According to an embodiment, the UE 510 and/or server 540 having TCP/UDP or application may perform optimization based on QoE, and the remaining entities may maintain the current control variable.

According to an embodiment, optimization may be applied to both DL/UL, and optimization may be performed by the UE 410 instead of the server 540. (e.g., dependent on the UE's scene change rate and network change rate).

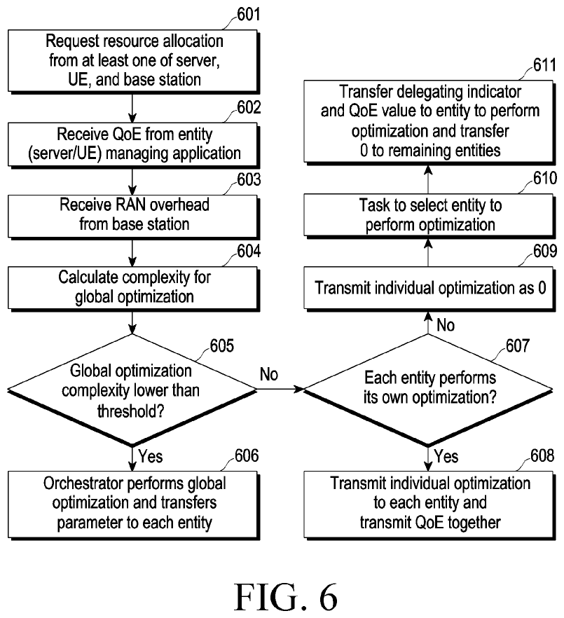

FIG. 6 is a view illustrating an operation method of an orchestrator according to an embodiment of the disclosure.

Referring to FIG. 6, in operation 601, an orchestrator may send a request for resource allocation to at least one of a UE, a base station, and a server. For example, the orchestrator may be implemented in the NWDAF or RIC. For example, the orchestrator may be implemented in a network function (NF) in the core network.

In operation 602, the orchestrator may receive QoE from an entity (e.g., the server and/or the UE) that manages the application. In operation 603, the orchestrator may receive a RAN overhead message from the base station. In operation 604, the orchestrator may calculate the complexity for global optimization for QoE.

According to an embodiment, the orders of operation 601, operation 602, operation 603, and operation 604 may be variously combined depending on the implementation.

In operation 605, the orchestrator may determine whether the complexity for global optimization is lower than a preset threshold.

If the complexity for global optimization is lower than the preset threshold (605-YES), in operation 606, the orchestrator may perform global optimization and transmit a parameter corresponding to the result of the global optimization to each entity (e.g., the server, the base station, and/or the UE).

If the complexity for global optimization is not lower than the preset threshold (605-NO), in operation 607, the orchestrator may determine whether to allow each entity (e.g., the server, the base station, and/or the UE) to perform QoE optimization separately.

If it is determined that each entity (e.g., the server, the base station, and/or the UE) is to separately perform optimization (607-YES), in operation 608, the orchestrator may transmit a separated optimization message (e.g., set to “1”) and QoE to each entity.

If it is determined that each entity (e.g., the server, the base station, and/or the UE) is not to separately perform optimization (607-NO), in operation 609, the orchestrator may transmit a separated optimization message (e.g., set to “0”).

In operation 610, the orchestrator may determine an entity to perform QoE optimization. In operation 611, the orchestrator may transmit a delegating indicator (e.g., set to “1”) and the QoE value to the entity (e.g., the server, the base station, and/or the UE) that is to perform QoE optimization. The orchestrator may transmit the delegating indicator (e.g., set to “0”) to the remaining entities that do not perform QoE optimization.

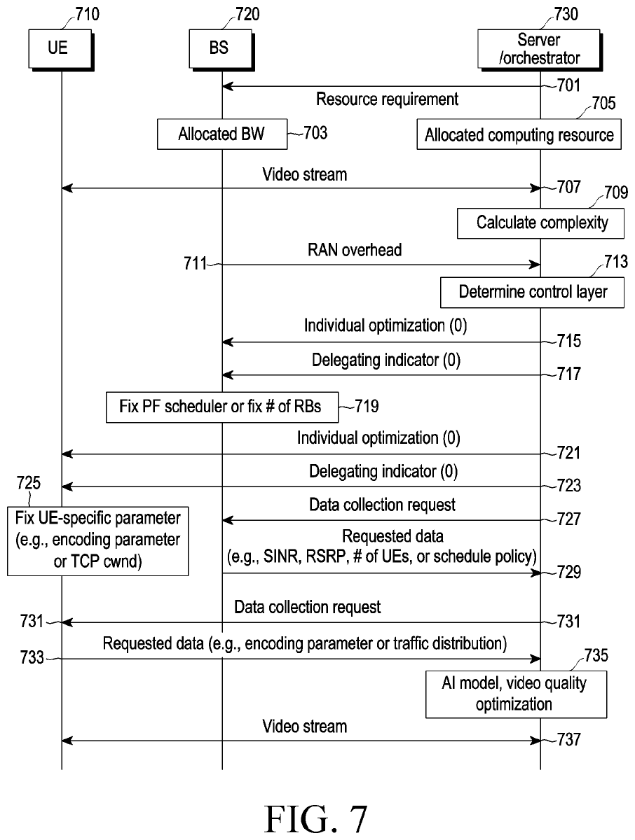

FIG. 7 is a view illustrating a QOE optimization method when an orchestrator is implemented in a server according to an embodiment of the disclosure.

Referring to FIG. 7, a wireless communication system may include a UE 710, a base station 720, and a server 730. According to an embodiment, the orchestrator may be implemented in the server 730.

In operation 701, the server 730 may exchange resource requirements with the base station 720. In operation 703, the base station 720 may identify an allocated bandwidth (BW). In operation 705, the server 730 may identify an allocated compute resource. In operation 707, the UE 710 may transmit and/or receive a video stream with the server 730 based on the allocated resource.

In operation 709, the server 730 may calculate the complexity based on information about QoE. In operation 711, the base station 720 may transmit the RAN overhead message to the server 730 to identify whether QoE optimization is possible in the base station 720. In operation 713, the server 730 may determine a control layer (or at least one entity) to perform QoE optimization.

In operation 715, the server 730 may transmit a separated optimization message (e.g., set to “0”) indicating that only one entity is to perform QoE optimization to the base station 720. In operation 717, the server 730 may transmit, to the base station 720, a delegating indicator (e.g., set to “0”) indicating that the base station 720 is not to perform QoE optimization. In operation 719, the base station 720 may fix a proportional fair (PF) scheduler related to QoE optimization or fix the number of RBs related to QoE optimization.

In operation 721, the server 730 may transmit a separated optimization message (e.g., set to “0”) indicating that only one entity is to perform QoE optimization to the UE 710. In operation 723, the server 730 may transmit, to the base station 720, a delegating indicator (e.g., set to “0”) indicating that the UE 710 is not to perform QoE optimization. In operation 725, UE 710 may fix UE-specific parameters (e.g., encoding parameters and/or TCP cwnd) related to QoE optimization.

According to an embodiment, the separated optimization message and the delegating indicator may be transmitted simultaneously. According to an embodiment, one message may be configured by combining the separated optimization message and the delegating indicator.

In operation 727, the server 730 may transmit a data collection request message requesting a parameter value required for QoE optimization to the base station 720. In operation 729, the server 730 may receive a parameter value (e.g., SINR, an RSRP, the number of connected UEs, an MCS selection criterion, and/or a schedule policy) required for QoE optimization from the base station 570.

In operation 731, the server 730 may transmit a data collection request message requesting a parameter value required for QoE optimization to the UE 710. In operation 733, the server 730 may receive a parameter (e.g., encoding parameter, and/or traffic distribution) required for QoE optimization from the UE 710.

In operation 735, the server 730 may optimize the AI model and/or video quality based on the parameter value required for QoE optimization received from the base station 720 in operation 729, and the parameter value required for QoE optimization received from the UE 710 in operation 733. In operation 737, the UE 710 may transmit and/or receive a video stream with the server 540 based on the resources allocated according to operation 719, 725, and 735.

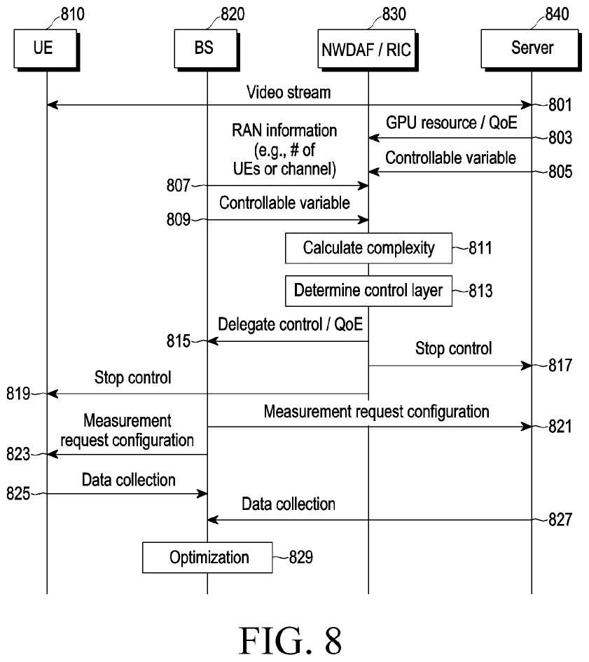

FIG. 8 is a view illustrating a QoE optimization method performed by a base station according to an embodiment of the disclosure.

Referring to FIG. 8, a wireless communication system may include a UE 810, a base station 820, an NWDAF (or RIC) 830, and a server 840.

In operation 801, the UE 810 may transmit and/or receive a video stream with the server 840. In operation 803, the server 840 may transmit information about GPU resources and QoE to the NWDAF (or RIC) 830. In operation 805, the server 840 may transmit information about a controllable variable to the NWDAF (or RIC) 830.

In operation 807, the base station 820 may transmit RAN information (e.g., the number of UEs and/or channel information) to the NWDAF (or RIC) 830. In operation 809, the base station 820 may transmit information about a controllable variable to the NWDAF (or RIC) 830.

In operation 811, the NWDAF (or RIC) 830 may calculate the complexity for QoE optimization based on the information received in operations 803 to 809. In operation 813, the NWDAF (or RIC) 830 may determine a control layer (or at least one entity) to perform QoE optimization.

In operation 813, if the NWDAF (or RIC) 830 determines the control layer to perform QoE optimization as the base station 820, in operation 815, the NWDAF (or RIC) 830 may transmit the delegate control message and QoE to the base station 820. In operation 817, the NWDAF (or RIC) 830 may transmit a stop control message to the base station 820. In operation 819, the NWDAF (or RIC) 830 may transmit a stop control message to the UE 810.

In operation 821, the base station 820 may transmit a measurement request config message to the server 840 to request data from the server 840. In operation 823, the base station 820 may transmit a measurement request config message to the UE 810 to request data from the server 840.

In operation 825, the base station 820 may receive data related to QoE collected from the UE 810. In operation 827, the server 840 may receive data related to QoE collected from the base station 820. In operation 829, the base station 820 may perform optimization for QoE based on data related to QoE received from the UE 810 and data related to QoE received from the base station 820.

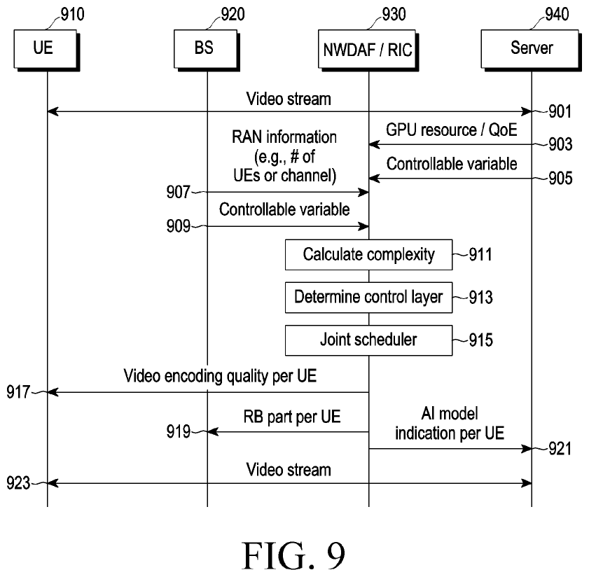

FIG. 9 is a view illustrating a process in which a network entity selects a control layer according to an embodiment of the disclosure.

Referring to FIG. 9, a wireless communication system may include a UE 910, a base station 920, an NWDAF (or RIC) 930, and a server 940. In FIG. 9, QoE optimization determination may be performed by NWDAF or RIC, and adaptive video encoding may be optimized by the NWDAF (RB control).

In operation 901, the UE 910 may transmit and/or receive a video stream with the server 940. In operation 903, the server 940 may transmit information about GPU resources and QoE to the NWDAF (or RIC) 930. In operation 905, the server 940 may transmit information about a controllable variable to the NWDAF (or RIC) 930.

In operation 907, the base station 920 may transmit RAN information (e.g., the number of UEs and/or channel information) to the NWDAF (or RIC) 930. In operation 909, the base station 920 may transmit information about a controllable variable to the NWDAF (or RIC) 930.

In operation 911, the NWDAF (or RIC) 930 may calculate the complexity for QoE optimization based on the information received in operations 903 to 909. In operation 913, the NWDAF (or RIC) 930 may determine a control layer (or at least one entity) to perform QoE optimization.

In operation 913, the NWDAF (or RIC) 930 may determine a control layer to perform QoE optimization. In operation 915, the NWDAF (or RIC) 930 may perform a joint scheduler function.

In operation 917, the NWDAF (or RIC) 930 may transmit information about video encoding quality per UE to the UE 910. In operation 919, the NWDAF (or RIC) 930 may transmit information about RB port per UE to the base station 920. In operation 919, the NWDAF (or RIC) 930 may transmit information (AI model per UE) on the AI model per UE to the server 940. In operation 923, the UE 910 may transmit and/or receive a video stream with the server 940.

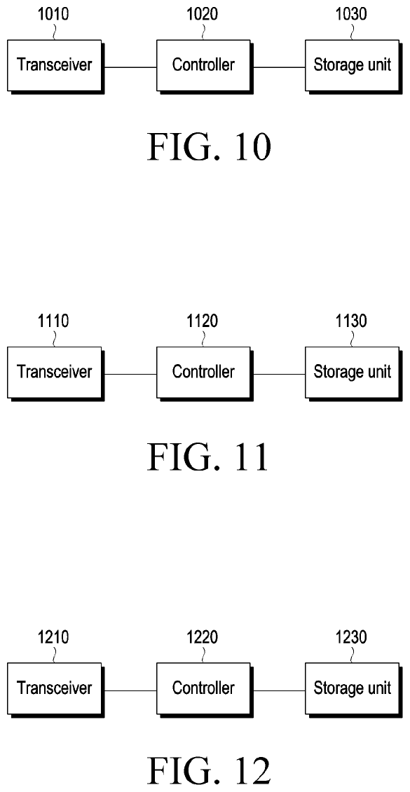

FIG. 10 illustrates a structure of a UE according to an embodiment of the disclosure.

The UE of FIG. 10 may be any one of the UEs described above in FIGS. 1 to 9. Referring to FIG. 10, the UE may include a transceiver 1010, a controller 1020, and a storage unit 1030. In the disclosure, the controller 1020 may be defined as a circuit or application-specific integrated circuit or at least one processor.

The transceiver 1010 may transmit and receive signals to and from other entities, and may also be referred to as a transmission/reception unit.

The controller 1020 may control the overall operation of the UE according to an embodiment proposed in the disclosure and may also be referred to as a processor. For example, the controller 1020 may control inter-block signal flow to perform the operations according to the above-described flowchart. Specifically, the controller 1020 may control the operations of the UE described above with reference to FIGS. 1 to 9.

The storage unit 1030 may store at least one of information transmitted/received via the transceiver 1010 and information generated via the controller 1020. For example, the storage unit 1030 may store information and data necessary for the method described above with reference to FIGS. 1 to 9.

FIG. 11 illustrates a structure of a base station according to an embodiment of the disclosure.

The base station in FIG. 11 may be any one of the above-described base stations in FIGS. 1 to 9. Referring to FIG. 11, the base station may include a transceiver 1110, a controller 1120, and a storage unit 1130. In the disclosure, the controller 1110 may be defined as a circuit or application-specific integrated circuit or at least one processor.

The transceiver 1110 may transmit and receive signals to and from other entities, and may also be referred to as a transmission/reception unit.

The controller 1120 may control the overall operation of the base station according to an embodiment proposed in the disclosure and may also be referred to as a processor. For example, the controller 1120 may control inter-block signal flow to perform the operations according to the above-described flowchart. Specifically, the controller 1120 may control the operations of the UE described above with reference to FIGS. 1 to 9.

The storage unit 1130 may store at least one of information transmitted/received via the transceiver 1110 and information generated via the controller 1120. For example, the storage unit 1130 may store information and data necessary for the method described above with reference to FIGS. 1 to 9.

FIG. 12 illustrates a structure of a network entity according to an embodiment of the disclosure.

The network entity of FIG. 12 may be any one of the network entities described above in FIGS. 1 to 9. The network entity of FIG. 12 may be an orchestrator or a server as described above in FIGS. 1 to 9. Referring to FIG. 12, the network entity may include a transceiver 1210, a controller 1220, and a storage unit 1230. In the disclosure, the controller 1220 may be defined as a circuit or application-specific integrated circuit or at least one processor.

The transceiver 1210 may transmit and receive signals to and from other entities, and may also be referred to as a transmission/reception unit.

The controller 1220 may control the overall operation of the network entity according to an embodiment proposed in the disclosure and may also be referred to as a processor. For example, the controller 1220 may control inter-block signal flow to perform the operations according to the above-described flowchart. Specifically, the controller 1220 may control the operations of the network entity described above with reference to FIGS. 1 to 9.

The storage unit 1230 may store at least one of information transmitted/received via the transceiver 1210 and information generated via the controller 1220. For example, the storage unit 1230 may store information and data necessary for the method described above with reference to FIGS. 1 to 9.

The methods according to the embodiments descried in the specification or claims of the disclosure may be implemented in hardware, software, or a combination of hardware and software. When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Or, the programs may be stored in memory constituted of a combination of all or some thereof. As each constituting memory, multiple ones may be included.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments of the disclosure via an external port. A separate storage device over the communication network may be connected to the device that performs embodiments of the disclosure.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Although specific embodiments of the present invention have been described above, various changes may be made thereto without departing from the scope of the present invention. Thus, the scope of the disclosure should not be limited to the above-described embodiments, and should rather be defined by the following claims and equivalents thereof.

1. A method for optimizing quality of experience (QoE) of a base station in a wireless communication system, the method comprising:
receiving, from a control entity (orchestrator), a first message (separated optimization(0)) indicating whether one network entity is to perform QoE optimization or each network entity is to perform QoE optimization;
receiving, from the control entity, a second message (delegating indicator(1)) indicating that the network entity to perform the QoE optimization is the base station;
receiving data for the QoE optimization from at least one of a user equipment (UE) and a server; and
performing the QoE optimization for the UE based on the data for the QoE optimization.

2. The method of claim 1, further comprising receiving, from the control entity, information about the QoE provided from the server.

3. The method of claim 1, further comprising transmitting a message requesting the data for the QoE optimization to at least one of the UE and the server.

4. The method of claim 1, wherein the data for the QoE optimization received from the UE includes at least one of an encoding parameter, traffic distribution information, pose information, and scene change information.

5. The method of claim 1, wherein the data for the QoE optimization received from the server includes at least one of an encoding rate and a traffic pattern report.

6. A method for optimizing quality of experience (QoE) of a server in a wireless communication system, the method comprising:
receiving, from a control entity (orchestrator), a first message (separated optimization(0)) indicating whether one network entity is to perform QoE optimization or each network entity is to perform QoE optimization;
receiving, from the control entity, a second message (delegating indicator(1)) indicating that the network entity to perform the QoE optimization is the server;
receiving data for the QoE optimization from at least one of a user equipment (UE) and a base station; and
performing the QoE optimization for the UE based on the data for the QoE optimization.

7. The method of claim 6, further comprising transmitting information about the QoE to the control entity.

8. The method of claim 6, further comprising transmitting a message requesting the data for the QoE optimization to at least one of the UE and the base station.

9. The method of claim 6, wherein the data for the QoE optimization received from the UE includes at least one of an encoding parameter, traffic distribution information, pose information, and scene change information.

10. The method of claim 6, wherein the data for the QoE optimization received from the base station includes at least one of a signal to interference plus noise ratio (SINR), a reference signals received power (RSRP), a number of UEs connected, a modulation coding scheme (MCS) selection criterion, and a schedule policy.

11. A base station for optimizing quality of experience (QoE) in a wireless communication system, comprising:
a transceiver; and
a controller configured to:
receive, from a control entity (orchestrator), a first message (separated optimization(0)) indicating whether one network entity is to perform QoE optimization or each network entity is to perform QoE optimization;
receive, from the control entity, a second message (delegating indicator(1)) indicating that the network entity to perform the QoE optimization is the base station;
receive data for the QoE optimization from at least one of a user equipment (UE) and a server; and
perform the QoE optimization for the UE based on the data for the QoE optimization.

12. The base station of claim 11, wherein the controller is configured to receive, from the control entity, information about the QoE provided from the server.

13. The base station of claim 11, wherein the controller is configured to transmit a message requesting the data for the QoE optimization to at least one of the UE and the server.

14. The base station of claim 11, wherein the data for the QoE optimization received from the UE includes at least one of an encoding parameter, traffic distribution information, pose information, and scene change information.

15. A server for optimizing quality of experience (QoE) in a wireless communication system, comprising:
a transceiver; and
a controller configured to:
receive, from a control entity (orchestrator), a first message (separated optimization(0)) indicating whether one network entity is to perform QoE optimization or each network entity is to perform QoE optimization;
receive, from the control entity, a second message (delegating indicator(1)) indicating that the network entity to perform the QoE optimization is the server;
receive data for the QoE optimization from at least one of a user equipment (UE) and a base station; and
perform the QoE optimization for the UE based on the data for the QoE optimization.
